(19) United States
(12) Patent Application Publication
(10) Pub. No.: US 2025/0053723 A1
(43) Pub. Date: Feb. 13, 2025

(54) METHOD AND APPARATUS FOR WHOLE-PROCESS PLACEMENT AND ROUTING INCREMENTAL OPTIMIZATION, AND COMPUTER DEVICE

(71) Applicant: Zhengxinyuan Technology (Hangzhou) Co.,Ltd., Handzhou (CN)

(72) Inventor: Lizheng ZHANG, Hangzhou (CN)

(21) Appl. No.: 18/467,205

(22) Filed: Sep. 14, 2023

(30) Foreign Application Priority Data
Aug. 10, 2023 (CN) 2023110113965

(51) Int. Cl. G06F 30/398

(52) U.S. Cl. CPC G06F 30/398

(57) ABSTRACT

The present disclosure provides a method and apparatus for whole-process placement and routing incremental optimization, and a computer device. The method includes: acquiring, based on a comprehensive timing analysis result after placement and routing, all violation cells that do not satisfy core constraints; determining, among all the violation cells, one or a plurality of independent target violation cells to be optimized; adjusting a position or area of each of the target violation cells and synchronously adjusting routing of a neighboring cell connected to the target violation cell to satisfy the core constraints; updating a placement and routing environment after optimization of the one or more independent target violation cells and outputting an updated comprehensive timing analysis result; judging, based on the updated comprehensive timing analysis result, whether violation cells are present; and if violation cells are present, reacquiring, in the new placement and routing environment, all violation cells that do not satisfy the core constraints, determining target violation cells to be optimized, and repeatedly performing the above optimization steps.

### BACKGROUND OF THE INVENTION

### Field of the Invention

The present disclosure relates to the field of electronic design automation for integrated circuits, in particular to a method and apparatus for whole-process placement and routing incremental optimization, and a computer device.

### Description of the Related Art

Placement and routing optimization is an important step in chip design for integrated circuits, and is the key for a chip to achieve performance, power, area (PPA) target values Existing placement and routing tools commonly use a batch mode to optimize cells after placement and routing. In the batch mode, many violation cells are changed and/or added before re-legalizing the entire placement and repairing the entire routing. That is, during batch mode optimization, all violation cells are optimized based on the same default placement and routing environment (i.e., a placement and routing environment generated before the optimization).

However, the fact is that after a first violation cell is optimized, the entire placement and routing environment is changed, and each subsequent violation cell is optimized in a changed placement and routing environment created after the optimization of a previous violation cell, instead of the default initial uniform placement and routing environment. In other words, except for the first violation cell, the rest of the violation cells are optimized in a different placement and routing environment from the default placement and routing environment. Since each subsequent violation cell is optimized in an inaccurate placement and routing environment, a timing after optimization may have large jumps, and these jumps may cause most of gains of PPA values obtained from optimization to disappear, which in turn may make the overall timing difficult to converge or very slow to converge. In addition, for each subsequent violation cell, the change of the real placement and routing environment may cause an actual violation state thereof to become uncertain, and optimization thereof may further deteriorate the timing.

### BRIEF SUMMARY OF THE INVENTION

In order to overcome the defects in the prior art, the present disclosure provides a method and apparatus for whole-process placement and routing incremental optimization, and a computer device.

In order to achieve the above objective, the present disclosure provides a method for whole-process placement and routing incremental optimization. The method includes:
acquiring, based on a comprehensive timing analysis result after placement and routing, all violation cells that do not satisfy core constraints;
determining, among all the violation cells, one or a plurality of independent target violation cells to be optimized, the plurality of independent target violation cells referring to a plurality of target violation cells that are uncorrelated both in terms of logical connections and spatial connections;
adjusting a position or area of each of the target violation cells and synchronously adjusting routing of a neighboring cell connected to the target violation cell to satisfy the core constraints;
updating a placement and routing environment after optimization of the one or more independent target violation cells and outputting an updated comprehensive timing analysis result;
judging, based on the updated comprehensive timing analysis result, whether violation cells are present; and if violation cells are present, reacquiring, in the new placement and routing environment, all violation cells that do not satisfy the core constraints, determining target violation cells to be optimized, and repeatedly performing the operations of optimizing the target violation cells, updating the placement and routing environment after optimization, judging, and determining the target violation cells among all the violation cells based on the updated comprehensive timing analysis result.

According to one embodiment of the present disclosure, after acquiring all violation cells in a current placement and routing environment, the method includes:
determining a logical connection for each of the violation cells based on a signal transmission path in a logical netlist;
determining a spatial connection for each of the violation cells based on a grid plan for each cell during placement and routing; and
determining a plurality of violation cells that are uncorrelated both in terms of logical connections and spatial connections as the plurality of independent target violation cells to be optimized.

According to one embodiment of the present disclosure, after the plurality of independent target violation cells are determined, all the independent target violation cells are synchronously optimized in parallel.

According to one embodiment of the present disclosure, the placement and routing refer to progressive synchronous placement and routing that gradually refine grids and subdivide cells, and the spatial connection for each of the violation cells is determined based on a position of an initial root cell to which the violation cell belongs within an initial coarse grid.

According to one embodiment of the present disclosure, after the comprehensive timing analysis result is obtained, all the violation cells are ranked based on timing margins, and a violation cell with a lowest timing margin is determined as a first target violation cell; and

the rest of the independent target violation cells are determined based on a relationship between other violation cells and the determined first target violation cell in terms of logical connections and spatial connections.

According to one embodiment of the present disclosure, after the comprehensive timing analysis result is obtained, a critical path is determined, and a violation cell with a lowest timing margin on the critical path is determined as a first target violation cell; and

the rest of the independent target violation cells are determined based on a relationship between other violation cells and the determined first target violation cell in terms of logical connections and spatial connections.

According to one embodiment of the present disclosure, the placement and routing refer to progressive synchronous placement and routing that gradually refine grids and subdivide cells, and during optimization of each of the target violation cells, the position of the target violation cell is adjusted within a grid region where a parent cell of the target violation cell is located.

In another aspect, the present disclosure provides an apparatus for whole-process placement and routing incremental optimization. The apparatus includes an acquiring module, a target determination module, an optimization module, an updating module, and a judging module. The acquiring module is configured to acquire, based on a comprehensive timing analysis result after placement and routing, all violation cells that do not satisfy core constraints. The target determination module is configured to determine, among all the violation cells, one or a plurality of independent target violation cells to be optimized, the plurality of independent target violation cells referring to a plurality of target violation cells that are uncorrelated both in terms of logical connections and spatial connections. The optimization module is configured to adjust a position or area of each of the target violation cells and synchronously adjust routing of a neighboring cell connected to the target violation cell to satisfy the core constraints. The updating module is configured to update a placement and routing environment after optimization of the one or more independent target violation cells and output an updated comprehensive timing analysis result. The judging module is configured to judge, based on the updated comprehensive timing analysis result, whether violation cells are present. If violation cells are present, the acquiring module is configured to reacquire, in the new placement and routing environment, all violation cells that do not satisfy the core constraints, determine target violation cells to be optimized, and repeatedly perform the operations of optimizing the target violation cells, updating the placement and routing environment after optimization, judging, and determining the target violation cells among all the violation cells based on the updated comprehensive timing analysis result.

According to one embodiment of the present disclosure, after acquiring all violation cells in a current placement and routing environment, the target determination module determines a plurality of independent target violation cells by:
determining a logical connection for each of the violation cells based on a signal transmission path in a logical netlist;
determining a spatial connection for each of the violation cells based on a grid plan for each cell during placement and routing; and
determining a plurality of violation cells that are uncorrelated both in terms of logical connections and spatial connections as the plurality of independent target violation cells to be optimized.

According to one embodiment of the present disclosure, the placement and routing refer to progressive synchronous placement and routing that gradually refine grids and subdivide cells, and the spatial connection for each of the violation cells is determined based on a position of an initial root cell to which the violation cell belongs within an initial coarse grid.

In yet another aspect, the present disclosure further provides a computer device. The computer device includes a memory, a processor, and a computer program stored on the memory and capable of running on the processor. The processor, when executing the computer program, implements the steps of any one of the foregoing methods for whole-process placement and routing incremental optimization.

In yet another aspect, the present disclosure further provides a computer-readable storage medium having a computer program stored thereon. The computer program, when executed by a processor, implements the steps of any one of the foregoing methods for whole-process placement and routing incremental optimization.

In summary, in the method for whole-process placement and routing incremental optimization according to the present disclosure, only one target violation cell or a plurality of independent target violation cells are optimized each time, and after the optimization, the placement and routing environment is updated and the updated comprehensive timing analysis result is output. By re-determining the target violation cells based on the updated comprehensive timing analysis result, the accuracy of the legitimate state of an optimization object is ensured. At the same time, due to the update of the placement and routing environment, the re-determined target violation cells are in a real optimization environment to effectively avoid a jump in timing after optimization, and the optimization process does not require repeated iterations, which makes the whole optimization process have better convergence, higher operation speed, and better PPA values. In addition, during determining the target violation cells, all violation cells are analyzed in two dimensions: logical connections and spatial connections to obtain the plurality of independent target violation cells. Based on the logical and spatial uncorrelation, the plurality of independent target violation cells can be optimized in the same round of cycle and the frequency of placement and routing updates is reduced significantly, which further improves the optimization rate.

In order to make the above and other objectives, features and advantages of the present disclosure more clearly understood, preferred embodiments are described below in detail in conjunction with the accompanying drawings.

### BRIEF DESCRIPTION OF THE DRAWINGS

FIG. 1 shows a schematic flow diagram of a method for whole-process placement and routing incremental optimization according to an embodiment of the present disclosure.

FIG. 2 shows a schematic diagram of progressive synchronous placement and routing that gradually refine a grid and subdivide cells.

FIG. 3 shows a schematic flow diagram of determining a plurality of independent target violation cells among all violation cells.

FIG. 4 shows a schematic flow diagram of a method for whole-process placement and routing incremental optimization according to another embodiment of the present disclosure.

FIG. 5 shows a schematic structural diagram of an apparatus for whole-process placement and routing incremental optimization according to an embodiment of the present disclosure.

### DETAILED DESCRIPTION OF THE INVENTION

In existing bath mode optimization for placement and routing, optimization of a first violation cell may cause a change in a placement and routing environment, so optimization of each subsequent violation cell is based on an inaccurate placement and routing environment. Further, the change in the placement and routing environment may also cause a legitimate state of subsequent violation cells to change, resulting in uncertainty in optimization, which makes it difficult to achieve balanced optimization in term of performance, power, and area due to a large jump in timing after optimization.

In view of this, this embodiment provides a method for whole-process placement and routing incremental optimization. The method includes: Step S10: Acquire, based on a comprehensive timing analysis result after placement and routing, all violation cells that do not satisfy core constraints. Step S20: Determine, among all the violation cells, one or a plurality of independent target violation cells to be optimized, the plurality of independent target violation cells referring to a plurality of target violation cells that are uncorrelated both in terms of logical connections and spatial connections. Step S30: Adjust a position or area of each of the target violation cells and synchronously adjust routing of a neighboring cell connected to the target violation cell to satisfy the core constraints. Step S40: Update a placement and routing environment after optimization of the one or the plurality of independent target violation cells and output an updated comprehensive timing analysis result. Step S50: Judge, based on the updated comprehensive timing analysis result, whether violation cells are present. If violation cells are present, steps S10 to S50 are performed again. That is, all violation cells that do not satisfy the core constraints are reacquired in the new placement and routing environment, target violation cells to be optimized are determined, and the operations of optimizing the target violation cells, updating the placement and routing environment after optimization, judging, and determining the target violation cells among all the violation cells based on the updated comprehensive timing analysis result are repeatedly performed.

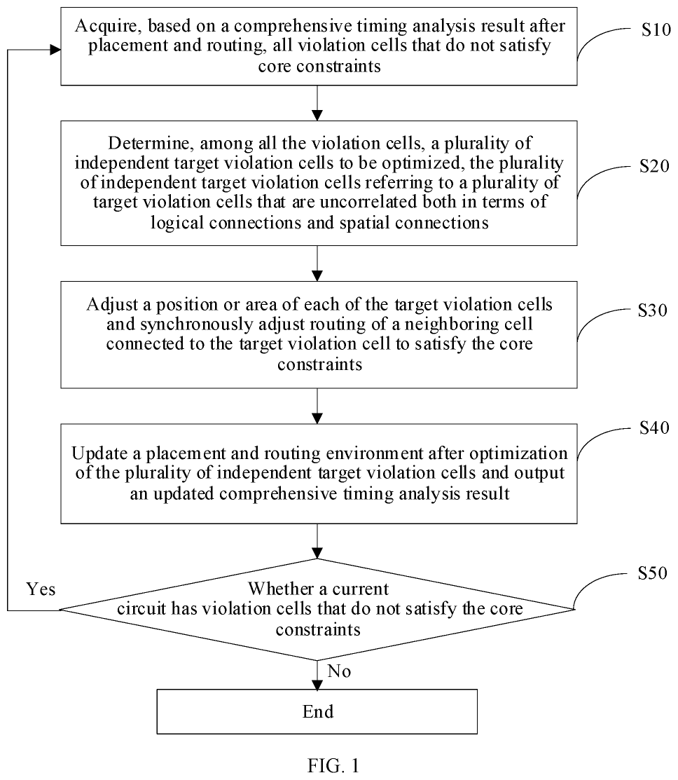

In order to make the objectives, technical solutions and advantages of the present application more clearly understood, the method for whole-process placement and routing incremental optimization according to this embodiment is illustrated in detail below in conjunction with FIG. 1 to FIG. 4. It is to be understood that the specific embodiments described herein are merely illustrative of the present application and are not intended to limit the present application.

After initial placement and routing, a timing analysis tool such as Quartus II performs comprehensive static timing analysis on a circuit. For example, Timing Analyzer in the timing analysis tool may verify the circuit performance and detect possible timing violations in terms of data demand time, data arrival time, clock arrival time, etc. Based on the possible timing violations, in step S10 in the method for whole-process placement and routing incremental optimization according to this embodiment, all the violation cells that do not satisfy the core constraints are acquired. A core constraint file includes a timing constraint file, a physical constraint file defined by a physical structure such as a chip shape, and a constraint rule preset before placement and routing such as a line width that characterizes the manufacturing capability of a process vendor.

After all the violation cells are obtained, step S20 is performed to determine the target violation cells to be optimized. The core of the method for whole-process placement and routing incremental optimization according to this embodiment is that after each round of optimization, the placement and routing environment is updated and the updated comprehensive timing analysis result is output, in order to ensure the accuracy of a legitimate state of each of the target violation cells and the placement and routing environment in which the target violation cell is located during subsequent optimization. However, in large-scale integrated circuits, repeated updates of the placement and routing environment and comprehensive timing analysis may affect the optimization rate to some extent. In fact, in the design of large-scale integrated circuits, there are many functional units involved in the circuits, some of which are relatively independent of each other, for example, an input unit and an output unit that are spatially located on both sides of a processing unit and logically independent of each other. For a plurality of violation cells that are uncorrelated to each other both in terms of logical connections and spatial connections, there is very little interference with each other in terms of timing constraints and physical constraints. Therefore, for large-scale integrated circuits, in step S20 where the optimization targets are determined, all the violation cells may be pre-analyzed in terms of logical connections and spatial connections to determine a plurality of independent target violation cells. The plurality of independent target violation cells refer to a plurality of target violation cells that are uncorrelated both in terms of logical connections and spatial connections.

In this embodiment, step S20 includes the following steps:

In step S201, a critical path is determined based on the timing violations output by Timing Analyzer after comprehensive timing analysis, and a violation cell with the lowest timing margin on the critical path is determined as a first target violation cell. The critical path refers to a timing path with the longest delay from input to output after placement and routing. However, the present disclosure does not limit this in any way. In other embodiments, all the violation cells may be ranked based on the timing violations output by Timing Analyzer in terms of timing margins, and then the violation cell with the lowest timing margin is determined as the first target violation cell.

In step S202, a logical relationship between other violation cells and the first target violation cell is sorted out based on a signal transmission path in a logical netlist, i.e., signal transmission from input to output.

In step S203, spatial connections between other violation cells and the first target violation cell determined in step S201 are determined based on a grid plan for each cell during the placement and routing. In existing placement and routing of integrated circuits, regardless of whether it is a congestion map-based placement before routing plan or progressive synchronous placement and routing, grid planning is used to locate the position of each module or cell. Therefore, in step S203, whether there is a spatial connection between cells is judged based on a grid region where each cell or a parent cell (or root cell) to which the cell belongs is located in the initial placement and routing. This embodiment is illustrated with the progressive synchronous placement and routing that gradually refine the grid and subdivide the cells as an example. The principle of the placement and routing is as follows:

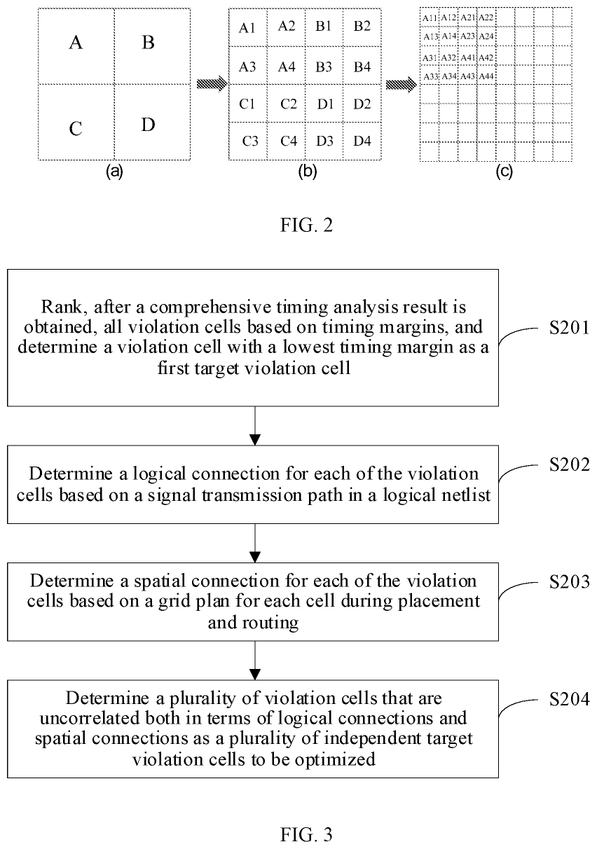

First, according to a netlist file and the core constraint file, each root cell is sequentially placed on an initial coarse grid, and routing between the root cell and other root cells that have been placed is performed synchronously. As shown in FIG. 2(a), four root cells A, B, C, and D are placed in the initial coarse grid, and each of the root cells includes a plurality of subdivided subcells. This embodiment is illustrated only with the placement and routing of the four root cells as an example. However, the present disclosure does not limit this in any way, and in an actual integrated circuit, a very large number of root cells may be formed depending on the function of the circuit.

Next, the grid is refined and each of the root cells is divided into a plurality of subcells. As shown in FIG. 2(b), a grid spacing after refinement is 50% of a previous grid spacing, i.e., a 2*2 grid is subdivided into a 4*4 grid. At the same time, the root cell A is divided into four subcells A1, A2, A3, and A4; the root cell B is divided into four subcells B1, B2, B3, and B4; the root cell C is divided into four subcells C1, C2, C3, and C4; and the root cell D is divided into four subcells D1, D2, D3, and D4. The four subcells A1, A2, A3, and A4 are placed within a region occupied by the root cell A in the initial grid, i.e., four grids in the upper left corner in FIG. 2(b). While the positions of the four subcells A1, A2, A3, and A4 are placed, routing among the four subcells is completed based on the core constraint file. Placement of the subcells B1-B4, C1-C4 and D1-D4 is completed in the same way.

Afterwards, the grid and the cells are further subdivided, and the grid is subdivided to form an 8*8 grid. The corresponding subcells are also subdivided into a plurality of subdivided subcells. For example, the subcell A1 is subdivided into four subdivided subcells A11, A12, A13, and A14; the subcell A2 is subdivided into four subdivided subcells A21-A24; the subcell A3 is subdivided into four subdivided subcells A31-A34; and the subcell A4 is subdivided into four subdivided subcells A41-A44. Afterwards, step S30 is repeatedly performed to place the four subdivided subcells A11-A14 within a region occupied by the subcell A1 in FIG. 2(b) (i.e., four grids in the upper left corner of FIG. 2(c)). At the same time, routing between the four subdivided subcells A11-A14 is completed synchronously. Synchronous placement and routing of other subdivided subcells are achieved in the same way. The grid and the subdivided subcells are continuously subdivided until placement and routing satisfy the core constraints of this stage.

Based on this placement and routing method, by taking the subdivided subcell A21 and the subdivided subcell B21 as an example, as the initial root cells (i.e., the cell A and the cell B) to which the two belong are located within two different regions of the initial grid respectively, it is determined that the subdivided subcell A21 and the subdivided subcell B21 are spatially uncorrelated.

In step S204, a plurality of violation cells that are uncorrelated to the first target violation cell determined in step S201 in terms of logical connections and spatial connections are acquired. The plurality of acquired violation cells and the first target violation cell together form the plurality of independent target violation cells.

For the resolution of the plurality of independent target violation cells both in terms of logical connections and spatial connections, it is preferred to filter out violation cells that are logically uncorrelated to the first target violation cell determined in step S201 based on the signal transmission path in the logical netlist; and then violation cells that are spatially uncorrelated to the first target violation cell are resolved among the plurality of violation cells that are logically uncorrelated to the first target violation cell, thus forming the plurality of independent target violation cells. However, the present disclosure does not limit this in any way. In other embodiments, filtering may be performed firstly based on spatial connections (i.e., step S203 is performed), and then further filtering is performed based on logical connections (i.e., step S202 is performed). Alternatively, in other embodiments, step S202 and step S203 may be performed synchronously, and finally an intersection operation is performed in step S204 to obtain the plurality of independent target violation cells.

In this embodiment, the plurality of independent target violation cells are determined by firstly determining the first target violation cell and then resolving the logical connections and the spatial connections to acquire the remaining independent target violation cells. However, the present disclosure does not limit this in any way. In other embodiments, all violation cells may be traversed in terms of logical connections and spatial connections respectively, and then the first target violation cell is determined.

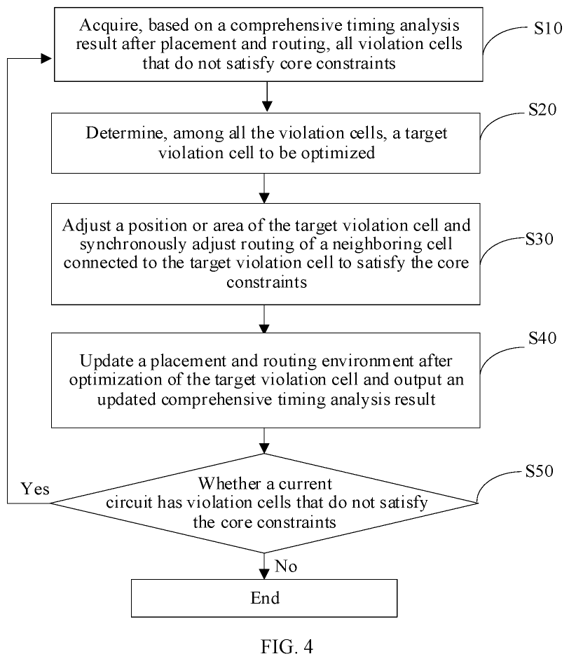

This embodiment is illustrated by taking step S20 where a plurality of independent target violation cells are determined as an example. However, the present disclosure does not limit this in any way. In other embodiments, for relatively small integrated circuits or integrated circuits with relatively large correlation of individual cells, in step S20, only one violation cell is determined as the target violation cell, as shown in FIG. 4. The target violation cell may be determined in the following ways. For example, the critical path may be determined based on the timing violations output by Timing Analyzer after the comprehensive timing analysis, and a violation cell with the lowest timing margin on the critical path is determined as the target violation cell. Alternatively, all violation cells may be ranked based on the timing violations output by Timing Analyzer in terms of timing margins, and then the violation cell with the lowest timing margin is determined as the target violation cell.

After the plurality of independent target violation cells are obtained, in step S30, the position or area of each of the target violation cells may be adjusted, and routing of the neighboring cell connected to the target violation cell is synchronously adjusted to satisfy the core constraints. Specifically, during adjustment of the position or area of each of the target violation cells, virtual routing is generated between the target violation cell and the neighboring cell connected thereto. Static timing analysis is performed on the virtual routing based on the core constraint file to generate an optimal movement position of the target violation cell within a current grid, and the corresponding virtual routing is converted to actual routing to legitimize the target violation cell and the neighboring cell connected thereto. As the length and width of each cell are pre-determined within a cell library, the structure of the cell and positions of a plurality of signal ends on the structure are also determined. Therefore, by capturing a center position of the target violation cell in real time and determining, based on the length and width of the target violation cell, the positions of the plurality of signal ends thereof, virtual routing may be generated between the positions of the signal ends thereof and signal ends of the neighboring cell. However, the present disclosure does not limit this in any way. In other embodiments, one of the signal ends of each of the target violation cells may also be used as an object to be captured in real time, and then the positions of other signal ends are calculated based on the structure of the cell.

As previously described, for progressive synchronous placement and routing that gradually refine the grid and subdivide the cells, during adjustment of the position of each of the target violation cells, the position of the target violation cell is adjusted within a grid region where a parent cell of the target violation cell is located. Taking the subdivided subcell A21 as an example, if the subdivided subcell is a target violation cell, during position adjustment in step S30, an adjustment range of the subdivided subcell is limited to a grid range where the parent cell A2 thereof is located, thereby effectively avoiding a large number of calculations caused by the position adjustment and movement within a large range, and greatly improving the efficiency of the optimization.

In addition, due to the uncorrelation of the plurality of independent target violation cells in terms of logical connections and spatial connections, in step S30, all the independent target violation cells may be synchronously optimized in parallel, which further improves the optimization rate. However, the present disclosure does not limit this in any way. In other embodiments, in step S30, the plurality of independent target violation cells may also be sequentially optimized in a certain order.

After step S30 where the one or the plurality of independent target violation cells are optimized, step S40, where the placement and routing environment after optimization is updated and comprehensive timing verification is performed to form the updated comprehensive timing analysis result, is performed.

In step S50, whether violation cells are present is judged based on the updated comprehensive timing analysis result. If a judgment result indicates that a current circuit still has violation cells that do not satisfy the core constraints, step S10 is re-performed based on the updated placement and routing environment and the comprehensive timing analysis result to start a new round of placement and routing optimization. In step S10, all violation cells that do not satisfy the core constraints are reacquired in the new placement and routing environment. In step S20, one or a plurality of independent target violation cells among the plurality of violation cells are determined as optimization objects based on timing margins or timing margins on the critical path. Step S30 is then repeatedly performed, where the position or area of each of the target violation cells is adjusted to make the target violation cell and the neighboring cell satisfy the core constraints, i.e., the target violation cell is converted from a violation state that violates the core constraints to a legitimate state. Afterwards, step S40 is performed again, where the placement and routing environment after optimization is updated and the updated comprehensive timing analysis result is output. If the circuit verification still fails to satisfy the core constraints, step S10 is performed again to start a new round of optimization.

In the existing batch mode optimization, the optimization of a previous violation cell causes a change in the placement and routing environment, so that on the one hand, the optimization of a later violation cell may be in an inaccurate environment, and on the other hand, a legitimate state of the later violation cell may become uncertain, and it is very likely that the violation cell is converted from an original violation state to a legitimate state, or a timing margin thereof may be further deteriorated. Due to the double inaccuracy of the state of the optimization object and the optimization environment, the existing batch optimization may have a large jump in timing during comprehensive validation, which requires a large number of iterations. Furthermore, the inaccuracy may also cause great difficulty to the iterative optimization, which results in the problem of slow convergence, or even the problem of non-convergence.

In the method for whole-process placement and routing incremental optimization according to the present disclosure, the output of the updated comprehensive timing analysis result in step S40 in the previous round of optimization ensures the accuracy of the state of the target violation cell selected in step S20 in the new round of timing optimization; and the update of the placement and routing environment after optimization ensures that the optimization of the target violation cell in the new round of optimization is achieved in a real and accurate environment. Due to the accuracy of both the state of the target violation cell and the optimization environment, the method for whole-process placement and routing incremental optimization according to the present disclosure may not have any jump in timing after optimization, which greatly shortens a large number of iterations caused by timing jumps and greatly increases the speed of timing optimization. At the same time, it may be easier to obtain an excellent PPA value on the circuit design.

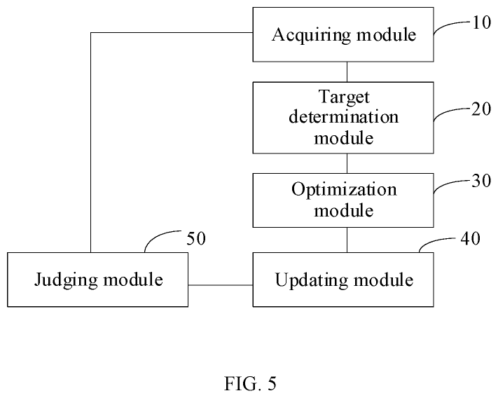

Corresponding to the foregoing method for whole-process placement and routing incremental optimization, this embodiment further provides an apparatus for whole-process placement and routing incremental optimization. As shown in FIG. 5, the apparatus for whole-process placement and routing incremental optimization includes an acquiring module 10, a target determination module 20, an optimization module 30, an updating module 40, and a judging module 50. The acquiring module 10 is configured to acquire, based on a comprehensive timing analysis result after placement and routing, all violation cells that do not satisfy core constraints. The target determination module 20 is configured to determine, among all the violation cells, one or a plurality of independent target violation cells to be optimized, the plurality of independent target violation cells referring to a plurality of target violation cells that are uncorrelated both in terms of logical connections and spatial connections. The optimization module 30 is configured to adjust a position or area of each of the target violation cells and synchronously adjust routing of a neighboring cell connected to the target violation cell to satisfy the core constraints. The updating module 40 is configured to update a placement and routing environment after optimization of the one or the plurality of independent target violation cells and output an updated comprehensive timing analysis result. The judging module 50 is configured to judge, based on the updated comprehensive timing analysis result, whether violation cells are present. If violation cells are present, the acquiring module 10 is configured to reacquire, in the new placement and routing environment, all violation cells that do not satisfy the core constraints, determine target violation cells to be optimized, and repeatedly perform the operations of optimizing the target violation cells, updating the placement and routing environment after optimization, judging, and determining the target violation cells among all the violation cells based on the updated comprehensive timing analysis result.

In one embodiment, after acquiring all violation cells in a current placement and routing environment, the target determination module 20 determines a plurality of independent target violation cells by the following steps:

In step S201, after the comprehensive timing analysis result is obtained, all the violation cells are ranked based on timing margins, and a violation cell with a lowest timing margin is determined as a first target violation cell; or after the comprehensive timing analysis result is obtained, a critical path is determined, and a violation cell with a lowest timing margin on the critical path is determined as a first target violation cell.

In step S202, a logical connection for each of the violation cells is determined based on a signal transmission path in a logical netlist.

In step S203, a spatial connection for each of the violation cells is determined based on a grid plan for each cell during placement and routing.

In step S204, a plurality of violation cells that are uncorrelated both in terms of logical connections and spatial connections are determined as the plurality of independent target violation cells to be optimized.

In one embodiment, placement and routing refer to progressive synchronous placement and routing that gradually refine a grid and subdivide cells, and the target determination module 20 determines the spatial connection for each of the violation cells based on a position of an initial root cell to which the violation cell belongs within an initial coarse grid.

In one embodiment, placement and routing refer to progressive synchronous placement and routing that gradually refine a grid and subdivide cells, and during optimization of each of the target violation cells, the optimization module 30 is configured to adjust the position of the target violation cell within a grid region where a parent cell of the target violation cell is located.

In one embodiment, after the plurality of independent target violation cells are determined, the optimization module 30 is configured to synchronously optimize all the independent target violation cells in parallel.

Specific limitations on the apparatus for whole-process placement and routing incremental optimization may be referred to the above limitations on the method for whole-process placement and routing incremental optimization, which will not be repeated herein. The various modules in the foregoing apparatus for whole-process placement and routing incremental optimization may be implemented in whole or in part by software, hardware, and combinations thereof. Each of the above modules may be embedded in hardware form in or independent of a processor in a computer device, or may be stored in software form in a memory in a computer device so as to be called by the processor to perform the operations corresponding to each of the above modules.

In one embodiment, a computer device is provided. The computer device includes a memory and a processor, and the memory has a computer program stored thereon. The computer program, when executed by the processor, causes the processor to perform the steps of the foregoing method for whole-process placement and routing incremental optimization. The steps of the method for whole-process placement and routing incremental optimization herein may be the steps in the method for whole-process placement and routing incremental optimization of the various embodiments described above.

In one embodiment, a computer-readable storage medium is provided. The computer-readable storage medium has a computer program stored thereon. The computer program, when executed by a processor, causes the processor to perform the steps of the foregoing method for whole-process placement and routing incremental optimization. The steps of the method for whole-process placement and routing incremental optimization herein may be the steps in the method for whole-process placement and routing incremental optimization of the various embodiments described above.

In summary, in the method for whole-process placement and routing incremental optimization according to the present disclosure, only one target violation cell or a plurality of independent target violation cells are optimized each time, and after the optimization, the placement and routing environment is updated and the updated comprehensive timing analysis result is output. By re-determining the target violation cells based on the updated comprehensive timing analysis result, the accuracy of the legitimate state of an optimization object is ensured. At the same time, due to the update of the placement and routing environment, the re-determined target violation cells are in a real optimization environment to effectively avoid a jump in timing after optimization, and the optimization process does not require repeated iterations, which makes the whole optimization process have better convergence, higher operation speed, and better PPA values. In addition, during determining the target violation cells, all violation cells are analyzed in two dimensions: logical connections and spatial connections to obtain the plurality of independent target violation cells. Based on the logical and spatial uncorrelation, the plurality of independent target violation cells can be optimized in the same round of cycle and the frequency of placement and routing updates is reduced significantly, which further improves the optimization rate.

Although the present disclosure has been described with reference to the above preferred embodiments, the present disclosure is not to be restricted by the preferred embodiments. It will be understood by those skilled in the art that various changes and modifications may be made without departing from the spirit and scope of the present disclosure as defined by the appended claims.

1. A method for whole-process placement and routing incremental optimization, comprising:
acquiring, based on a comprehensive timing analysis result after placement and routing, all violation cells that do not satisfy core constraints;
determining, among all the violation cells, one or a plurality of independent target violation cells to be optimized, the plurality of independent target violation cells referring to a plurality of target violation cells that are uncorrelated both in terms of logical connections and spatial connections;
adjusting a position or area of each of the target violation cells and synchronously adjusting routing of a neighboring cell connected to the target violation cell to satisfy the core constraints;
updating a placement and routing environment after optimization of the one or more independent target violation cells and outputting an updated comprehensive timing analysis result;
judging, based on the updated comprehensive timing analysis result, whether violation cells are present; and if violation cells are present, reacquiring, in the new placement and routing environment, all violation cells that do not satisfy the core constraints, determining target violation cells to be optimized, and
repeatedly performing the operations of optimizing the target violation cells, updating the placement and routing environment after optimization, judging, and determining the target violation cells among all the violation cells based on the updated comprehensive timing analysis result.

2. The method for whole-process placement and routing incremental optimization according to claim 1, wherein after acquiring all violation cells in a current placement and routing environment, the method comprises:
determining a logical connection for each of the violation cells based on a signal transmission path in a logical netlist;
determining a spatial connection for each of the violation cells based on a grid plan for each cell during placement and routing; and
determining a plurality of violation cells that are uncorrelated both in terms of logical connections and spatial connections as the plurality of independent target violation cells to be optimized.

3. The method for whole-process placement and routing incremental optimization according to claim 2, wherein after the plurality of independent target violation cells are determined, all the independent target violation cells are synchronously optimized in parallel.

4. The method for whole-process placement and routing incremental optimization according to claim 2, wherein after the plurality of independent target violation cells are determined, the plurality of independent target violation cells are sequentially optimized in a certain order, then the placement and routing environment after optimization is updated, and the updated comprehensive timing analysis result is output.

5. The method for whole-process placement and routing incremental optimization according to claim 2, wherein the placement and routing refer to progressive synchronous placement and routing that gradually refines grids and subdivide cells, and the spatial connection for each of the violation cells is determined based on a position of an initial root cell to which the violation cell belongs within an initial coarse grid.

6. The method for whole-process placement and routing incremental optimization according to claim 1, wherein after the comprehensive timing analysis result is obtained, all the violation cells are ranked based on timing margins, and a violation cell with a lowest timing margin is determined as a first target violation cell; and
the rest of the independent target violation cells are determined based on a relationship between other violation cells and the determined first target violation cell in terms of logical connections and spatial connections.

7. The method for whole-process placement and routing incremental optimization according to claim 1, wherein after the comprehensive timing analysis result is obtained, a critical path is determined, and a violation cell with a lowest timing margin on the critical path is determined as a first target violation cell; and
the rest of the independent target violation cells are determined based on a relationship between other violation cells and the determined first target violation cell in terms of logical connections and spatial connections.

8. The method for whole-process placement and routing incremental optimization according to claim 1, wherein the placement and routing refer to progressive synchronous placement and routing that gradually refine grids and subdivide cells, and during optimization of each of the target violation cells, the position of the target violation cell is adjusted within a grid region where a parent cell of the target violation cell is located.

9. The method for whole-process placement and routing incremental optimization according to claim 8, wherein during adjusting the position or area of each of the target violation cells, generating virtual routing between the target violation cell and the neighboring cell connected thereto; and performing, based on a core constraint file, static timing analysis on the virtual routing to generate an optimal movement position of the target violation cell within a current grid, and converting the corresponding virtual routing to actual routing to legitimize the target violation cell and the neighboring cell connected thereto.

10. An apparatus for whole-process placement and routing incremental optimization, comprising:
an acquiring module configured to acquire, based on a comprehensive timing analysis result after placement and routing, all violation cells that do not satisfy core constraints;
a target determination module configured to determine, among all the violation cells, one or a plurality of independent target violation cells to be optimized, the plurality of independent target violation cells referring to a plurality of target violation cells that are uncorrelated both in terms of logical connections and spatial connections;
an optimization module configured to adjust a position or area of each of the target violation cells and synchronously adjust routing of a neighboring cell connected to the target violation cell to satisfy the core constraints;
an updating module configured to update a placement and routing environment after optimization of the one or more independent target violation cells and output an updated comprehensive timing analysis result; and
a judging module configured to judge, based on the updated comprehensive timing analysis result, whether violation cells are present, wherein if violation cells are present, the acquiring module is configured to reacquire, in the new placement and routing environment, all violation cells that do not satisfy the core constraints, determine target violation cells to be optimized, and repeatedly perform the operations of optimizing the target violation cells, updating the placement and routing environment after optimization, judging, and determining the target violation cells among all the violation cells based on the updated comprehensive timing analysis result.

11. The apparatus for whole-process placement and routing incremental optimization according to claim 10, wherein after acquiring all violation cells in a current placement and routing environment, the target determination module determines a plurality of independent target violation cells by:
determining a logical connection for each of the violation cells based on a signal transmission path in a logical netlist;
determining a spatial connection for each of the violation cells based on a grid plan for each cell during placement and routing; and
determining a plurality of violation cells that are uncorrelated both in terms of logical connections and spatial connections as the plurality of independent target violation cells to be optimized.

12. The apparatus for whole-process placement and routing incremental optimization according to claim 11, wherein the placement and routing refer to progressive synchronous placement and routing that gradually refine grids and subdivide cells, and the spatial connection for each of the violation cells is determined based on a position of an initial root cell to which the violation cell belongs within an initial coarse grid.

13. The apparatus for whole-process placement and routing incremental optimization according to claim 11, wherein after the plurality of independent target violation cells are determined, the optimization module is configured to synchronously optimize all the independent target violation cells in parallel.

14. The apparatus for whole-process placement and routing incremental optimization according to claim 11, wherein after the plurality of independent target violation cells are determined, the optimization module is configured to sequentially optimize the plurality of independent target violation cells in a certain order; and then the updating module is configured to update the placement and routing environment after optimization and output the updated comprehensive timing analysis result.

15. The apparatus for whole-process placement and routing incremental optimization according to claim 10, wherein after the comprehensive timing analysis result is obtained, the target determination module is configured to rank all the violation cells based on timing margins, and determine a violation cell with a lowest timing margin as a first target violation cell; and
the rest of the independent target violation cells are determined based on a relationship between other violation cells and the determined first target violation cell in terms of logical connections and spatial connections.

16. The apparatus for whole-process placement and routing incremental optimization according to claim 10, wherein after the comprehensive timing analysis result is obtained, the target determination module is configured to determine a critical path, and determine a violation cell with a lowest timing margin on the critical path as a first target violation cell; and
the rest of the independent target violation cells are determined based on a relationship between other violation cells and the determined first target violation cell in terms of logical connections and spatial connections.

17. The apparatus for whole-process placement and routing incremental optimization according to claim 10, wherein the placement and routing refer to progressive synchronous placement and routing that gradually refine grids and subdivide cells, and during optimization of each of the target violation cells, the optimization module is configured to adjust the position of the target violation cell within a grid region where a parent cell of the target violation cell is located.

18. The apparatus for whole-process placement and routing incremental optimization according to claim 17, wherein the optimization module is configured to: during adjusting the position or area of each of the target violation cells, generate virtual routing between the target violation cell and the neighboring cell connected thereto; and perform, based on a core constraint file, static timing analysis on the virtual routing to generate an optimal movement position of the target violation cell within a current grid, and convert the corresponding virtual routing to actual routing to legitimize the target violation cell and the neighboring cell connected thereto.

19. A computer device, comprising a memory, a processor, and a computer program stored on the memory and capable of running on the processor, wherein the processor, when executing the computer program, implements the steps of the method for whole-process placement and routing incremental optimization according to claim 1.

20. A computer-readable storage medium having a computer program stored thereon, wherein the computer program, when executed by a processor, implements the steps of the method for whole-process placement and routing incremental optimization according to claim 1.
